(19) United States
(12) Patent Application Publication
(10) Pub. No.: US 2011/0261314 A1
(43) Pub. Date: Oct. 27, 2011

(54) LENS ASSEMBLY FOR VIEWING THREE-DIMENSIONAL (3D) IMAGES PROVIDED WITH READILY DETACHABLE FUNCTIONAL PRESCRIPTION LENS

(75) Inventor: Su AN PARK, Wonju-si (KR)

(73) Assignee: KOREA O.G.K CO., LTD., Wonju-si (KR)

(21) Appl. No.: 12/816,540

(22) Filed: Jun. 16, 2010

(30) Foreign Application Priority Data
Apr. 23, 2010 (KR) 10-2010-0038063

(51) Int. Cl. G02C 7/08; G02B 27/26

(52) U.S. Cl. 351/57; 359/465

(57) ABSTRACT

Disclosed is a lens assembly for viewing three-dimensional (3D) images integrated with an easily detachable functional prescription lens, wherein a lens for viewing three dimensional images is provided with a gasket and the gasket is integrated with a prescription lens, thus considerably advantageously realizing three dimensional imaging without wearing any prescription lens.

### BACKGROUND OF THE INVENTION

1. Field of the Invention

The present invention relates to a lens assembly for viewing three-dimensional (3D) images integrated with a prescription lens. More specifically, the present invention relates to a lens assembly for viewing three-dimensional (3D) images wherein a lens for viewing three dimensional images is provided with a gasket and the gasket is integrated with a prescription lens, thus considerably advantageously realizing three dimensional imaging without wearing any prescription lens.

2. Description of the Related Art

A polarizing lens provided with a phase difference film is required in order to realize three-dimensional imaging with superior dimensional effects and clear image quality. Polarizing lenses for viewing three-dimensional images are generally divided into active-type and passive-type polarizing lenses and are suitable for users having normal vision. Accordingly, users having low vision should wear a specific lens linked to general eyeglasses through a fix clip.

The passive lens for viewing three-dimensional images has a structure wherein a PVA film is adhered to the outer side of the PC panel and a phase difference film is adhered to the outer side of the PVA film.

In addition, the passive lens for viewing three-dimensional images has a structure wherein a TAC panel is adhered to both sides of a PVA film provided in the center thereof and a phase difference film is adhered to the side of the outer TAC panel. The passive lens has a multilayer structure, thus involving considerable difficultly in manufacture and being unsuitable for users having poor eyesight.

When viewers having poor eyesight wear a lens for viewing three-dimensional images, they must use the lens in combination with a prescription lens, that is, they must wear two glasses simultaneously, thus disadvantageously causing considerable user discomfort and being unable to render viewing with superior three-dimensional effects and clear image quality due to light refraction or deterioration in light transmission in the space provided between the prescription lens and the 3D lens.

Accordingly, the present invention solves the aforementioned problems, i.e., inconvenience of users having different eyesights and drawbacks of conventional lens assemblies for viewing three-dimensional (3D) images.

### SUMMARY OF THE INVENTION

Therefore, the present invention has been made in view of the above problems and it is one object of the present invention to provide a lens assembly for viewing three-dimensional (3D) images integrated with a prescription lens processed to be suited to the eyesight of a viewer wherein a lens for viewing 3D images is adhered to a gasket and the gasket is integrated with the prescription lens, thus considerably advantageously realizing three dimensional imaging without wearing any prescription lens.

It is another object of the present invention to provide a lens assembly for viewing three-dimensional (3D) images which eliminates the necessity of wearing a prescription lens on a 3D lens, thus advantageously providing comfortable and clear image-quality imaging.

In accordance with one aspect of the present invention, provided is a lens assembly for viewing three-dimensional (3D) images including a passive lens (using a polarizing film), wherein a prescription lens provided with a gasket is joined to the side of the passive lens to impart convenient use to users.

Also, provided is a lens assembly for viewing three-dimensional (3D) images provided with an easily detachable functional prescription lens, the lens assembly including; a PVA film having an outer side linked to a phase difference film; a PC panel linked to the inner side of the PVA film; and a prescription lens provided with a gasket, joined to the inner side of the PC panel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an assembled perspective view illustrating eyeglasses for viewing three-dimensional (3D) images of the present invention;

FIG. 2 is an assembled perspective view illustrating eyeglasses for viewing three-dimensional (3D) images of the present invention;

FIG. 3 is an exploded sectional view illustrating a lens assembly for viewing three-dimensional (3D) images of the present invention;

FIG. 4 is an exploded sectional view illustrating a lens assembly for viewing three-dimensional (3D) images of the present invention;

FIG. 5 is an exploded sectional view illustrating a lens assembly for viewing three-dimensional (3D) images of the present invention;

FIG. 6 is an exploded sectional view illustrating a lens assembly for viewing three-dimensional (3D) images of the present invention;

FIG. 7 is an exploded sectional view illustrating a lens assembly for viewing three-dimensional (3D) images of the present invention;

FIG. 8 is an exploded sectional view illustrating a lens assembly for viewing three-dimensional (3D) images of the present invention;

FIG. 9 is an exploded sectional view illustrating a lens assembly for viewing three-dimensional (3D) images of the present invention; and

FIG. 10 is an exploded sectional view illustrating a lens assembly for viewing three-dimensional (3D) images of the present invention.

### DETAILED DESCRIPTION OF THE INVENTION

Hereinafter, preferred embodiments of the present invention will be described with reference to the annexed drawings in detail.

Since embodiments described in the description and constructions illustrated in the drawings are only exemplary embodiments of the present invention and do not mean all of the sprit and scope of the present invention, it will be understood that various modifications and substitutions as alternatives of the embodiments may be made therein at the filing date.

As used herein, a passive lens portion 60 refers to an imaging system using a polarizing film.

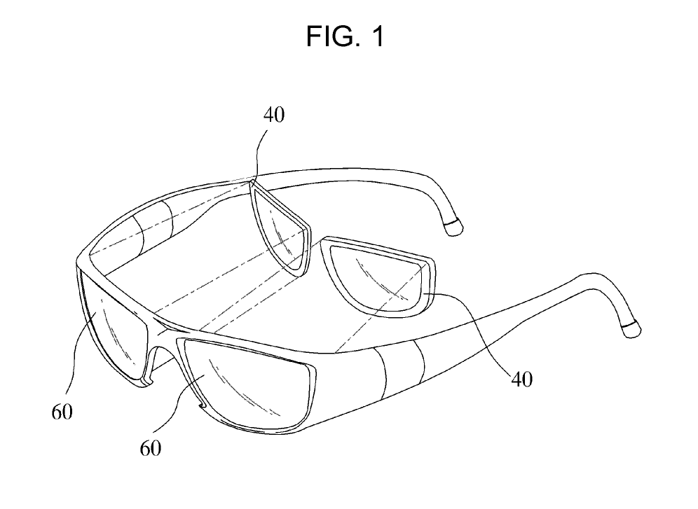

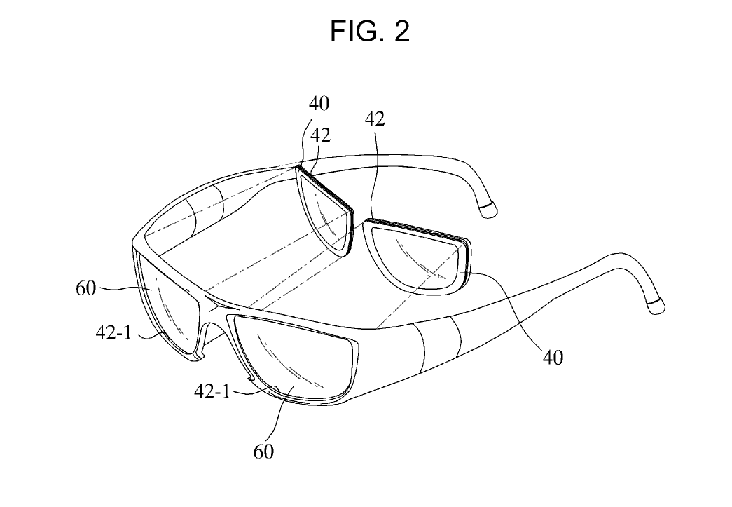

FIGS. 1 and 2 are assembled perspective views illustrating a prescription lens wherein a gasket is mounted on a lens portion 60 of a 3D lens eyeglass.

The present invention provides a lens assembly for viewing three-dimensional (3D) images provided with an easily detachable functional prescription lens wherein a prescription lens for vision correction provided with a gasket 40 is joined to the inner side of a passive lens portion 60 (toward the eye of a wearer) providing three-dimensional images.

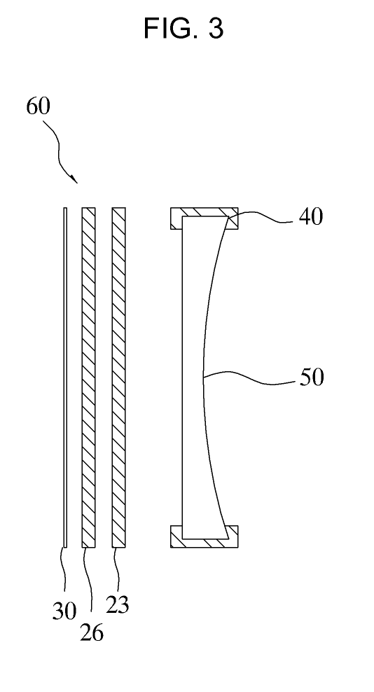

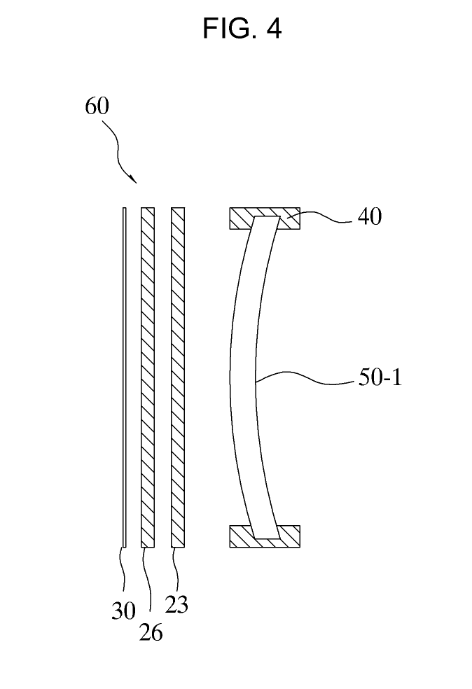

As shown in FIG. 3, for the lens assembly for viewing three-dimensional (3D) images of the present invention, the prescription lens has a flat outer surface and a concave (or convex) inner surface. In addition, as shown in FIG. 4, for the lens assembly for viewing three-dimensional (3D) images of the present invention, the prescription lens 50-1 has a convex outer side and a concave inner side. The prescription lens is composed of a material selected from CR, PC, glass, organic compounds and acryl.

For the lens assembly for viewing three-dimensional (3D) images, the gasket 40 has a projection 42 to be mounted on a groove 42-1 provided in a 3D eyeglass frame, to provide easy mount and demount.

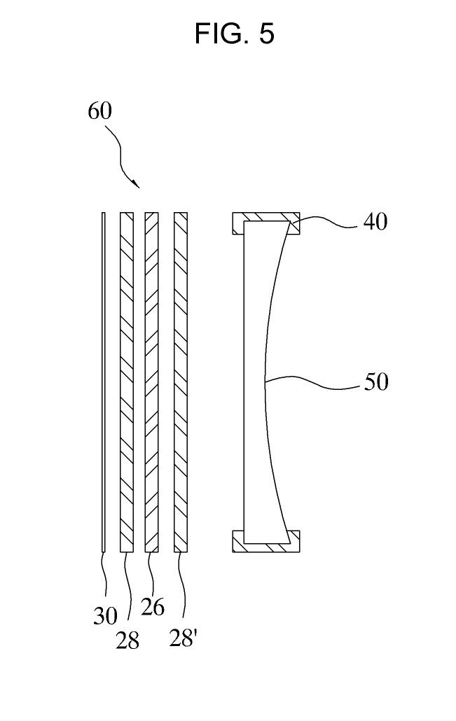

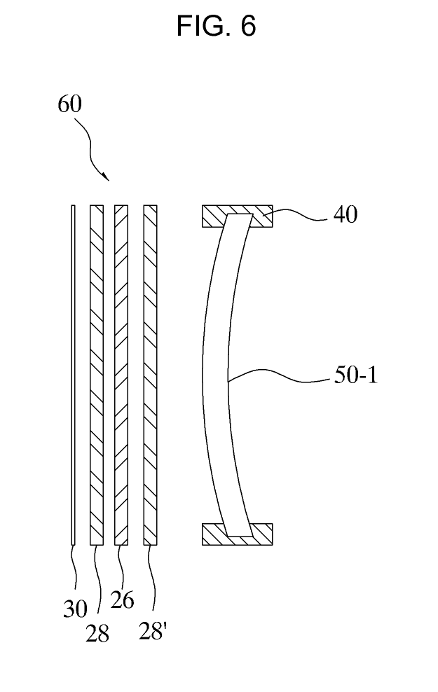

As shown in FIGS. 5 and 6, in one embodiment, provided is a lens assembly for viewing three-dimensional (3D) images integrated with a prescription lens, the lens assembly comprising a PVA film 26 provided in the center thereof; TAC panels 28 and 28′ adhered to both sides of the PVA film 26; a phase difference film 30 adhered to the outer side of the outer TAC panel 28; a gasket 40 adhered to the inner side of the inner TAC panel 28′; and a prescription lens 50 or 50-1 mounted on the gasket 40.

As shown in FIG. 5, for the lens assembly for viewing three-dimensional (3D) images, the prescription lens 50 has a flat outer surface and a concave inner surface. In addition, as shown in FIG. 6, for the lens assembly of the present invention for viewing three-dimensional (3D) images, the prescription lens 50-1 has a convex outer surface and a concave inner surface. The prescription lens is composed of a material selected from CR, PC, glass, acryl, organic compounds and polymers. The gasket 40 has a projection 42 to be mounted on a groove 42-1 provided in an eyeglass frame.

The lens assembly for viewing three-dimensional (3D) images has a structure wherein a monolithic lens for viewing three-dimensional (3D) images is integrated with a prescription lens realizing three dimensional imaging without wearing any prescription glasses 50 and 50-1 and processed to be suited to the eyesight of a viewer, thus being suitable for the eyesight of a wearer and realizing comfortable wearing, while viewing high-quality images without wearing any prescription glasses. Hereinafter, the specific configurations of the present invention will be illustrated with reference to the annexed drawings in detail.

As shown in FIGS. 3 and 4, for the passive lens portion 60 of the lens assembly for viewing three-dimensional (3D) images, the PVA film 26 having an outer side linked to a phase difference film 30 and an inner side linked to a PC panel 23, a gasket 40 is linked to the inner side of the PC panel 23 and a prescription lens 50 or 50-1 is linked to the gasket 40. The PVA (polyvinyl alcohol) film 26 provided in the center thereof is prepared through stretching and dying processes including stretching a film in one direction and arranging a substance such as iodine, dichroic dyes or the like between a PVA polymer in the other direction, so that the PVA film 4 passes light emitted in one direction and absorbs light emitted in the other direction, thereby acting as a polarizer. The passive lens portion 60 comprises the prescription lens provided with the gasket.

As shown in FIGS. 5 and 6, the passive lens portion has a structure wherein TAC films 28 and 28′ adhered to the outer sides of a PVA film 26 and a phase difference film 30 is adhered to the outer side of the outer TAC film 28, wherein the phase difference film 30 enables separate transfer of left/right imaging and polarizing to the eyes of viewers through the lens and realizes binocular disparity, enabling three-dimensional imaging. In order to realize three-dimensional imaging with superior three-dimensional effects and clear image quality, wearing a polarizing lens provided with the phase difference film is required. In addition, as shown in FIGS. 5 and 6, for the lens assembly for viewing 3D images, TAC (triacetyl cellulose) films 28 and 28′ integrally adhered to both sides of the PVA (polyvinyl alcohol) film 26 provided in the center thereof are oriented in an optically identical direction and exhibit superior transparency and strength, and good dimensional stability when faced with variations in temperature and humidity. In this embodiment, the passive lens portion 60 comprises the prescription lens 50 or 50-1 provided with the gasket.

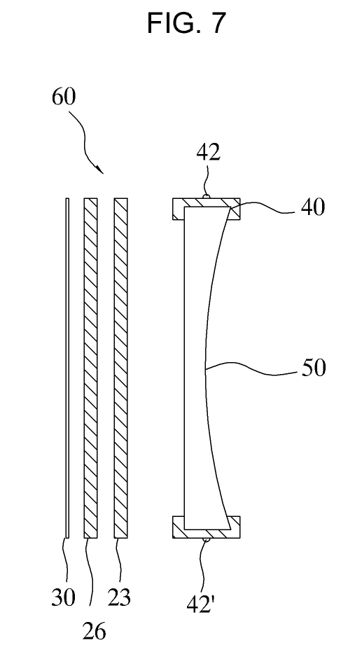

Accordingly, for the lens assembly for viewing three-dimensional (3D) images, a gasket 40 is mounted on the inner side of the inner TAC film 28′ and a prescription lens 50 or 50-1 is adhered to the gasket 40. The prescription lens 50 or 50-1 is processed based on the previously measured eyesight of the user, which is composed of a material selected from CR and PC which exhibit the same effects. As shown in FIGS. 3 to 6, for the lens assembly, the prescription lens 50 or 50-1 is adhered to the gasket 40, and the prescription lens 50 or 50-1 may have a flat outer surface and a concave inner surface, or may have a convex outer surface and a concave inner surface. As shown in FIGS. 3 to 6, the prescription lens may be composed of a material selected from CR, PC, glass, organic compounds and acryl. As shown in FIGS. 7 to 10, for the lens assembly for viewing three-dimensional (3D) images, the gasket 40 has a projection 42, enabling the lens to be conveniently mounted and demounted on a groove 42-1 provided in an eyeglass frame.

In another embodiment, as shown in FIGS. 5 and 6, for the lens assembly for viewing 3D images, a PVA film 26 is provided in the center thereof; TAC films 28 and 28′ are adhered to both sides of the PVA film 26 to protect the PVA film 26; and a phase difference film 30 is adhered to the outer side of the outer TAC panel 28. The phase difference film 30 enables separate transfer of left/right imaging and polarizing to the eyes of viewers through the lens and realizes binocular disparity, enabling three-dimensional imaging. In order to realize three-dimensional imaging with superior three-dimensional effects and clear image quality, wearing a polarizing lens provided with the phase difference film is required. The prescription lens 50 or 50-1 is composed of a material selected from CR, PC, glass, acryl, andorganic compounds and is processed to suit to the eyesight of the user.

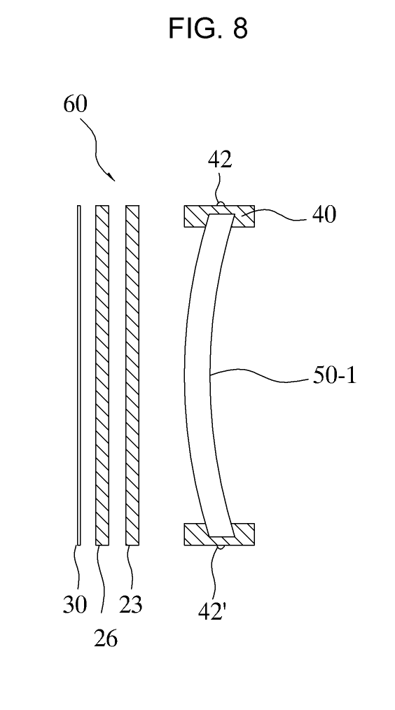

As shown in FIGS. 7 and 8, for the lens assembly for viewing 3D images, a PVA film 26 has an outer side linked to a phase difference film 30 and an inner side linked to a PC panel 23, a gasket 40 is provided with a projection 42 is linked to the inner side of the PC panel 23, wherein the prescription lens may have a flat outer surface and a concave or convex inner surface, or may have a convex outer surface and a concave or convex inner surface.

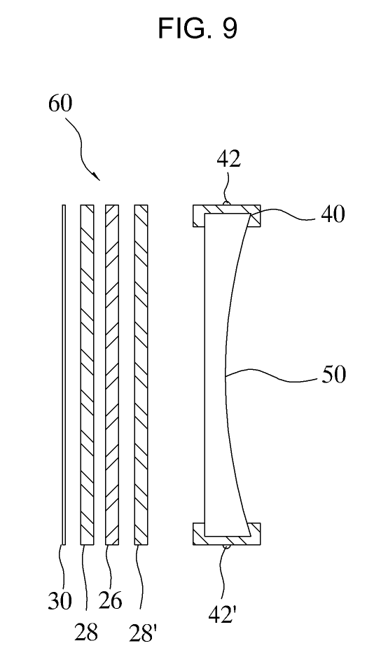

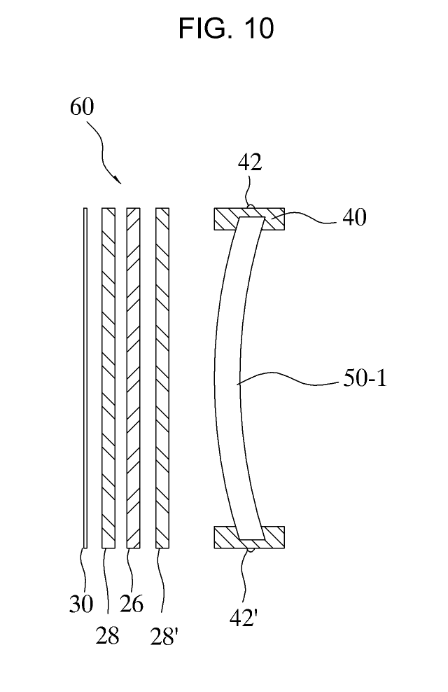

As shown in FIGS. 9 and 10, the passive lens portion comprises a PVA film 26 provided in the center thereof; TAC panels 28 and 28′ adhered to both sides of the PVA film 26; a phase difference film 30 adhered to the outer side of the outer TAC panel 28; a gasket 40 provided with a projection, adhered to the inner side of the inner TAC panel 28′; and a prescription lens 50 or 50-1 mounted on the gasket 40.

The prescription lens may have a flat outer surface and a concave or convex inner surface. Alternatively, the prescription lens may have a convex outer surface and a concave or convex inner surface.

As shown in FIGS. 2, and 7 to 10, a groove 42-1 is formed in a 3D eyeglass frame including a lens assembly for viewing three-dimensional (3D) images and a gasket provided with a projection 42 is mounted on the groove 42-1 to allow users to easily detach the prescription lens.

As apparent from the fore-going, the present invention advantageously provides a lens assembly for viewing three-dimensional (3D) images integrated with a prescription lens processed to be suited to the eyesight of a viewer wherein a lens for viewing 3D images is adhered to a gasket and the gasket is integrated with the prescription lens, thus considerably advantageously realizing three dimensional imaging without wearing any prescription lens.

The lens for viewing three-dimensional images is integrated with a gasket-provided prescription lens processed to be suited to the low eyesight of a viewer, thus advantageously providing comfortable wearing and clear 3D imaging. In addition, the lens assembly advantageously prevents shock between the 3D lens and the prescription lens and permeation of foreign materials therebetween.

The lens assembly eliminates the necessity of wearing a prescription lens on a lens for viewing three dimensional images, thus advantageously providing comfortable, clear, and superior image-quality imaging and thus realizing more interesting 3D imaging.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A lens assembly for viewing three-dimensional (3D) images provided with an easily detachable functional prescription lens, realizing three-dimensional (3D) viewing through a passive lens portion (using a polarizing film), wherein a prescription lens for vision correction provided with a gasket is joined to the inner side (toward the eye of a wearer) of the passive lens portion providing three-dimensional (3D) images.

2. The lens assembly according to claim 1, wherein the passive lens portion comprises:
a PVA film having an outer side linked to a phase difference film; and
a PC panel linked to an inner side of the PVA film.

3. The lens assembly according to claim 1, wherein the prescription lens has a convex outer surface and a concave or convex inner surface.

4. The lens assembly according to claim 1, wherein the prescription lens has a flat outer surface and a concave or convex inner surface.

5. The lens assembly according to claim 1, wherein the prescription lens is composed of a material selected from CR, PC, glass, organic compounds and acryl.

6. The lens assembly according to claim 1, wherein the gasket has a projection to be mounted on a groove provided in an eyeglass frame.

7. The lens assembly according to claim 1, wherein the passive lens portion comprises:
a PVA film provided in the center thereof;
a pair of TAC panels adhered to both sides of the PVA film;
a phase difference film adhered to the outer side of the outer TAC panel;
a gasket adhered to the inner side of the inner TAC panel; and
a prescription lens mounted on the gasket.

8. The lens assembly according to claim 7, wherein the prescription lens has a convex outer surface and a concave or convex inner surface.

9. The lens assembly according to claim 7, wherein the prescription lens has a flat outer surface and a concave or convex inner surface.

10. The lens assembly according to claim 7, wherein the prescription lens is composed of a material selected from CR, PC, glass, acryl and organic compounds.

11. The lens assembly according to claim 7, wherein the gasket has a projection to be mounted on a groove provided in an eyeglass frame.

12. The lens assembly according to claim 1, wherein providing the gasket to the prescription lens and joining the prescription lens to the inner side of the 3D lens are carried out using a method selected from sticking, adhering and engaging.
